(19) United States
(12) Patent Application Publication
(10) Pub. No.: US 2003/0214967 A1
(43) Pub. Date: Nov. 20, 2003

(54) Method of remote channel quality determination

(76) Inventor: Allen D. Heberling, Fairfax, VA (US)

Correspondence Address: XTREMESPECTRUM, INC., 8133 LESSBURG PIKE, SUITE 700, VIENNA, VA, 22182, US

(21) Appl. No.: 10/438,982

(22) Filed: May 16, 2003

Related U.S. Application Data
(60) Provisional application No. 60/380,835, filed on May 17, 2002.

(51) Int. Cl. H04J 3/16

(52) U.S. Cl. 370/437

(57) ABSTRACT

A method is provided for making a quality determination for a plurality of signal channels in an ultrawide bandwidth local network that will not require a coordinator associated with the network to suspend network operation. This is achieved by having the coordinator send a channel quality request to a non-coordinator device in the network. This non-coordinator device then performs a channel quality determination to determine channel quality information about the plurality of signal channels. After it has completed the channel quality determination, the non-coordinator device then sends the channel quality information from the non-coordinator device to the coordinator device. And if the non-coordinator device can accomplish the channel quality determination quickly enough, it need not even remove itself from the network, even temporarily.

### CROSS REFERENCE TO RELATED APPLICATIONS

The present document claims the benefit of the earlier filing date of commonly owned, co-pending U.S. provisional patent application Serial No. 60/380,835, filed May 17, 2002, entitled METHOD OF REMOTE SCANNING, the contents of which are incorporated by reference in its entirety.

### BACKGROUND OF THE INVENTION

The present invention relates to wireless personal area networks and wireless local area networks. More particularly, the present invention relates to systems, methods, devices, and computer program products for allowing a wireless network coordinator to determine the status of a plurality of available channels without temporarily shutting down the network. Even more particularly, the present invention relates to systems, methods, devices, and computer program products for allowing an ultrawide bandwidth wireless network coordinator to determine the status of a plurality of available channels.

The International Standards Organization's (ISO) Open Systems Interconnection (OSI) standard provides a seven-layered hierarchy between an end user and a physical device through which different systems can communicate. Each layer is responsible for different tasks, and the OSI standard specifies the interaction between layers, as well as between devices complying with the standard. One possible implementation of the OSI standard is in wireless ultrawide bandwidth (UWB) communications.

FIG. 1 shows the hierarchy of the seven-layered OSI standard. As seen in FIG. 1, the OSI standard 100 includes a physical layer 110, a data link layer 120, a network layer 130, a transport layer 140, a session layer 150, a presentation layer 160, and an application layer 170.

The physical (PHY) layer 110 conveys the bit stream through the network at the electrical, mechanical, functional, and procedural level. It provides the hardware means of sending and receiving data on a carrier. The data link layer 120 describes the representation of bits on the physical medium and the format of messages on the medium, sending blocks of data (such as frames) with proper synchronization. The networking layer 130 handles the routing and forwarding of the data to proper destinations, maintaining and terminating connections. The transport layer 140 manages the end-to-end control and error checking to ensure complete data transfer. The session layer 150 sets up, coordinates, and terminates conversations, exchanges, and dialogs between the applications at each end. The presentation layer 160 converts incoming and outgoing data from one presentation format to another. The application layer 170 is where communication partners are identified, quality of service is identified, user authentication and privacy are considered, and any constraints on data syntax are identified.

The IEEE 802 Committee has developed a three-layer architecture for local networks that roughly corresponds to the physical layer 110 and the data link layer 120 of the OSI standard 100. FIG. 2 shows the IEEE 802 standard 200.

As shown in FIG. 2, the IEEE 802 standard 200 includes a physical (PHY) layer 210, a media access control (MAC) layer 220, and a logical link control (LLC) layer 225. The PHY layer 210 operates essentially as the PHY Layer 110 in the OSI standard 100. The MAC and LLC layers 220 and 225 share the functions of the data link layer 120 in the OSI standard 100. The LLC layer 225 places data into frames that can be communicated at the PHY layer 210; and the MAC layer 220 manages communication over the data link, sending data frames and receiving acknowledgement (ACK) frames. Together the MAC and LLC layers 220 and 225 are responsible for error checking as well as retransmission of frames that are not received and acknowledged.

FIG. 3 is a block diagram of a wireless network 305 that could use the IEEE 802 standard 200, specifically the proposed IEEE 802.15.3 standard. In a preferred embodiment the network 305 is a wireless personal area network (WPAN), or piconet. However, it should be understood that the present invention also applies to other settings where bandwidth is to be shared among several users, such as, for example, wireless local area networks (WLAN), or any other appropriate wireless network.

When the term piconet is used, it refers to a network of devices connected in an ad hoc fashion, having one device act as a coordinator (i.e., it functions as a master) while the other devices follow the instructions of the coordinator (i.e., they function as clients). The coordinator can be a designated device, or simply one of the devices chosen to function as a coordinator. In any piconet, every non-coordinator device 221-225 that is associated must be able to hear a beacon sent out by the coordinator 310. Consequently, every non-coordinator device 321-325 must be able to communicate with the coordinator 310, but not necessarily with each other.

As shown in FIG. 3, the network 305 includes a coordinator 310 and a plurality of non-coordinator devices 321-325. The coordinator 310 serves to coordinate the operation of the network 305. As noted above, the system of coordinator 310 and non-coordinator devices 321-325 may be called a piconet, in which case the coordinator 310 may be referred to as a piconet coordinator (PNC). Each of the non-coordinator devices 321-325 must be connected to the coordinator 310 via primary wireless links 330, and may also be connected to one or more other non-coordinator devices 321-325 via secondary wireless links 340. Each non-coordinator device 321-325 of the network 305 may be a different wireless device, for example, a digital still camera, a digital video camera, a personal data assistant (PDA), a digital music player, or other personal wireless device.

In some embodiments the coordinator 310 may be the same sort of device as any of the non-coordinator devices 321-325, except with the additional functionality for coordinating the system and the requirement that it every non-coordinator device 321-325 be able to hear the coordinator 310 at the appropriate time. In other embodiments the coordinator 310 may be a separate designated control device.

The various non-coordinator devices 321-325 are confined to a usable physical area 350, which is set based on the extent to which the coordinator's 310 beacon can successfully be heard by each of the non-coordinator devices 321-325. Any non-coordinator device 321-325 that is able to receive the coordinator's beacon and is able to communicate with the coordinator 310 (and vice versa) is within the usable area 350 of the network 305. As noted, however, it is not necessary for every non-coordinator device 321-325 in the network 305 to communicate with every other non-coordinator device 321-325.

FIG. 4 is a block diagram of a coordinator 310 or a non-coordinator device 321-325 from the network 305 of FIG. 3. As shown in FIG. 4, each coordinator 310 or non-coordinator device 321-325 includes a physical (PHY) layer 410, a media access control (MAC) layer 420, a set of upper layers 430, and a management entity 440.

The PHY layer 410 communicates with the rest of the network 305 via a primary or secondary wireless link 330 or 340. It generates and receives data in a transmittable data format and converts it to and from a format usable through the MAC layer 420. The MAC layer 420 serves as an interface between the data formats required by the PHY layer 410 and those required by the upper layers 430. The upper layers 205 include the functionality of the non-coordinator device 321-325. These upper layers 430 may include TCP/IP, TCP, UDP, RTP, IP, LLC, 1394, USB or the like.

Typically, the coordinator 310 and the non-coordinator devices 321-325 in a WPAN share the same bandwidth. Accordingly, the coordinator 310 coordinates the sharing of that bandwidth. Standards have been developed to establish protocols for sharing bandwidth in a wireless personal area network (WPAN) setting. For example, the IEEE standard 802.15.3 is being developed to provide a specification for the PHY layer 410 and the MAC layer 420 in such a setting where bandwidth is shared using time division multiple access (TDMA). Using this standard, the MAC layer 420 defines frames and super-frames through which the sharing of the bandwidth by the non-coordinator devices 321-325 is managed by the coordinator 310 and/or the non-coordinator devices 321-325.

FIG. 5 illustrates an exemplary structure of a series of super-frames having a plurality of time slots during a contention free period according to a conventional method of operation. As shown in FIG. 5, the data transmission scheme includes transmitting successive super-frames 550 in time across the network 300. Each super-frame 550 includes a beacon frame 560, an optional contention access period (CAP) 570, and a channel time allocation period (CTAP) 580. The channel time allocation period 580 includes one or more time slots 590. These can be guaranteed time slots (GTSs), management time slots (MTSs), or other types of time slots, as desired by the network operation.

The super-frame 550 itself is a fixed time construct that is repeated in time. The specific duration of the super-frame 550 is described in the beacon frame 560. In actuality the beacon frame 560 includes information regarding how often the beacon 560 is repeated, which effectively corresponds to the duration of the super-frame 550. The beacon 560 also contains information regarding the network 300 and the identity of the coordinator 310.

In operation, the coordinator 310 uses the beacon 560 to define and assign the time slots 590. All non-coordinator devices 321-325 listen to the coordinator 310 during the beacon period 560. Each non-coordinator device 321-325 will receive zero or more time slots 590, being notified of each start time and duration from the coordinator 310 during the beacon period 560. This beacon information uses what is often called TLV format, which stands for type, length, and value. As a result, each device knows when to transmit and when to receive. The beacon period 560, therefore, is used by the coordinator to coordinate the transmitting and receiving of the non-coordinator devices 321-325.

The coordinator 310 sends the beacon 560 to all of the non-coordinator devices 321-325 at the beginning of each super-frame 550. The beacon 560 tells each non-coordinator device 321-325 the duration or super-frame 550 as well as other information about its MAC address, e.g., the size and duration of the contention access period 570, if any, and the duration of the channel time allocation period 580.

Each beacon 560 will contain information that is not precisely a channel time allocation (CTA). One piece of information will define the beacon period 560 and describe the start time and the duration for the beacon period 560. Another will define the contention access period 570, if any, and describe the start time and the duration for the channel time allocation period 570. Each beacon can also have multiple CTAs. There will be a CTA for each of the time slots 590. Using dynamic time slots 590, the slot assignments can change every super-frame with modified CTAs.

The network can pass control and administrative information between the coordinator 310 and the various non-coordinator devices 321-325 through the contention access period 570 or during a management time slot. For example, this can involve information about new devices that want to join the network 300.

If a new device 321-325 desires to be added to the network 300, it requests entry from the coordinator 310 in the contention access period 330 or during an association management time slot.

Individual devices then transmit data packets during the channel time allocation period 480. The devices 310, 321-325 use the time slots 490 assigned to them to transmit data packets to other devices (which may include the coordinator 310 if the coordinator 310 is also a device 321-325 within the network 300). Each device 310, 321-325 may send one or more packets of data, and may request an immediate acknowledgement (ACK) frame from the recipient device 310, 321-325 indicating that the packet was successfully received, or may request a delayed (grouped) acknowledgement. If an immediate ACK frame is requested, the transmitting device 310, 321-325 should allocate sufficient time in the time slot 490 to allow for the ACK frame to arrive.

It is necessary to organize which devices 310, 321-325 will be transmitting and which will be listening to avoid collisions of transmitted data. For example if device one 321 and device four 324 both try and transmit data at the same time, this data may collide and cause the receiving devices to fail in acquiring and receiving the signal.

The reason we allocate individual time slots 590 in the super-frame 550 is because when a given device, e.g., device one 321, is transmitting to another device, e.g., device five 325, it's really broadcasting its signal to everyone, i.e., broadcasting on the open air where anyone who happens to be listening can hear. We would prefer that while device one 321 was transmitting, device five 325 was the only device that was listening. This is basically a TDMA approach. Since the broadcast medium is wireless, when one device is transmitting the system has to limit who else can use the channel.

Since each particular device 310, 321-325 knows its transmit start time and duration from information received during the beacon period 560, each device 310, 321-325 can remain silent until it is its turn to transmit.

The time slots 590 shown in this embodiment may be of differing sizes. The starting times and durations of the time slots 590 are determined by the coordinator 310 and sent to the non-coordinator devices 321-325 in the beacon 560.

One problem that can arise in a wireless network is interference, either with other networks, or unrelated interference sources. This interference can reduce the ability of the network 300 to pass information at a desired data rate, or at all. One way to address this issue is to use multiple channels, each of which may have different interference characteristics. When a network 300 is first started, the coordinator 310 can listen to all of the channels and pick the one that is the most clear.

It therefore becomes necessary for the coordinator to keep track of the quality of the local transmission medium (i.e., the channels), so that it can take appropriate measures should interference get too great.

In order to determine the quality of all available channels, the coordinator 310 must suspend all network activity and listen to all possible channels. After it has listened to all available channels, the coordinator 310 can then determine which is the best channel to use, based on certain selection criteria (e.g., low noise in the channel or no other networks operating in the same channel).

Thus, to make a channel quality determination, network activity must be stopped. However, that comes with a price of lost transmission time, which may violate Quality of Service (QoS) requirements in a network. Such QoS requirements may have set bandwidths that must be guaranteed. Furthermore, if a strict timing transmission protocol is used (e.g., TDMA), the network may not be able to halt operations.

It would therefore be advantageous to provide a way for a coordinator 310 to determine channel quality without temporarily shutting down the network 300.

### SUMMARY OF THE INVENTION

Consistent with the title of this section, only a brief description of selected features of the present invention is now presented. A more complete description of the present invention is the subject of this entire document.

A feature of the present invention is to determine the quality of multiple available channels in an ultrawide bandwidth network without stopping operation of the network.

Another feature of the present invention is to have a coordinator in an ultrawide bandwidth wireless network request that a non-coordinator device perform a channel quality determination so that the coordinator can maintain operation of the network.

Some of these objects are accomplished by way of a method of making a quality determination for a plurality of signal channels in a wireless network. The method may comprise: sending a channel quality request from a coordinator device in the network to a non-coordinator device in the network; performing a channel quality determination at the non-coordinator device to determine channel quality information about the plurality of signal channels; and sending the channel quality information from the non-coordinator device to the coordinator device.

The step of performing the channel quality determination may be accomplished by having the non-coordinator device monitor each of the plurality of signal channels in turn.

Each of the plurality of signal channels may have a different carrier frequency, a different center frequency, may operate at a unique CDMA code, or may have a different combination of center frequency and CDMA code.

The non-coordinator device may suspend normal operation during the step of performing channel quality determination. The non-coordinator device may not participate in communication with the network during the step of performing the channel quality determination.

The channel quality information may indicate the presence or absence of radio frequency interference in each signal channel. The channel quality information may further indicate the periodicity of any radio frequency interference in each signal channel.

The wireless network may be an ultrawide bandwidth network.

Some of these objects are also accomplished by way of a method of making a quality determination for a plurality of signal channels in a first wireless network. This method comprises: sending a channel quality request from a coordinator device in the local network to a non-coordinator device in the network; performing a channel quality determination at the non-coordinator device to determine channel quality information about the plurality of signal channels; and sending the channel quality information from the non-coordinator device to the coordinator device. The channel quality information in this method may indicate the presence or absence of one or more overlapping wireless networks on one or more of the plurality of signal channels.

The channel quality information may further indicate the identities of any overlapping wireless networks. The channel quality information may also further indicate the presence or absence of radio frequency interference, as well as the periodicity of any radio frequency interference.

The step of performing the channel quality determination may be accomplished by having the non-coordinator device monitor each of the plurality of signal channels in turn.

Each of the plurality of signal channels may have a different carrier frequency, a different center frequency, may operate at a unique CDMA code, or may have a different combination of center frequency and CDMA code.

The first wireless network and any overlapping wireless networks may be ultrawide bandwidth networks.

### BRIEF DESCRIPTION OF THE DRAWINGS

A more complete appreciation of the present invention and many of the attendant advantages thereof will be readily obtained as the same becomes better understood by reference to the following detailed description when considered in connection with the accompanying drawings. In these drawings like reference numerals designate identical or corresponding parts throughout the several views.

FIG. 1 is a block diagram of the OSI standard for a computer communication architecture;

FIG. 2 is a block diagram of the IEEE 802 standard for a computer communication architecture;

FIG. 3 is a block diagram of a wireless network;

FIG. 4 is a block diagram of a device or coordinator in the wireless network of FIG. 3;

FIG. 5 illustrates an exemplary structure of a series of super-frames having a plurality of time slots during a contention free period; and

FIG. 6 is a flow chart showing a process by which a coordinator 310 can determine the channel quality without stopping network operation, according to a preferred embodiment of the present invention.

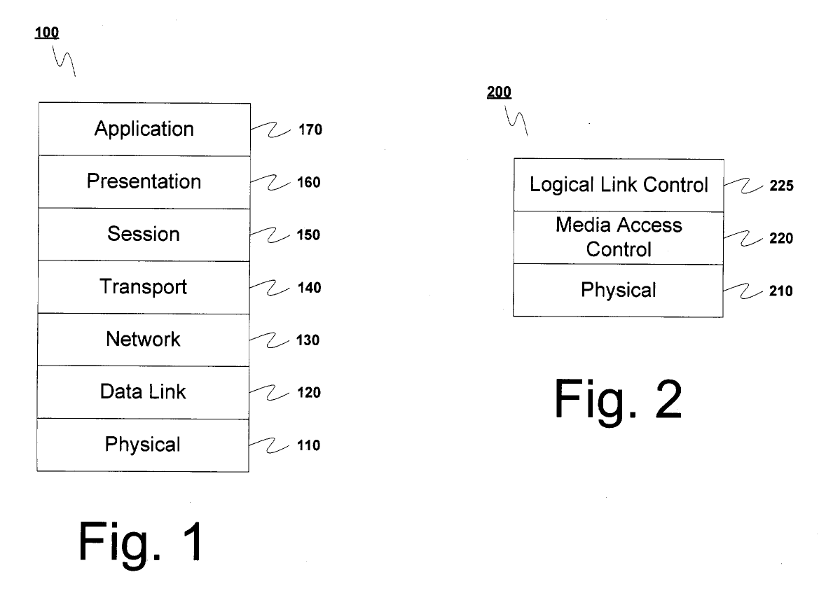

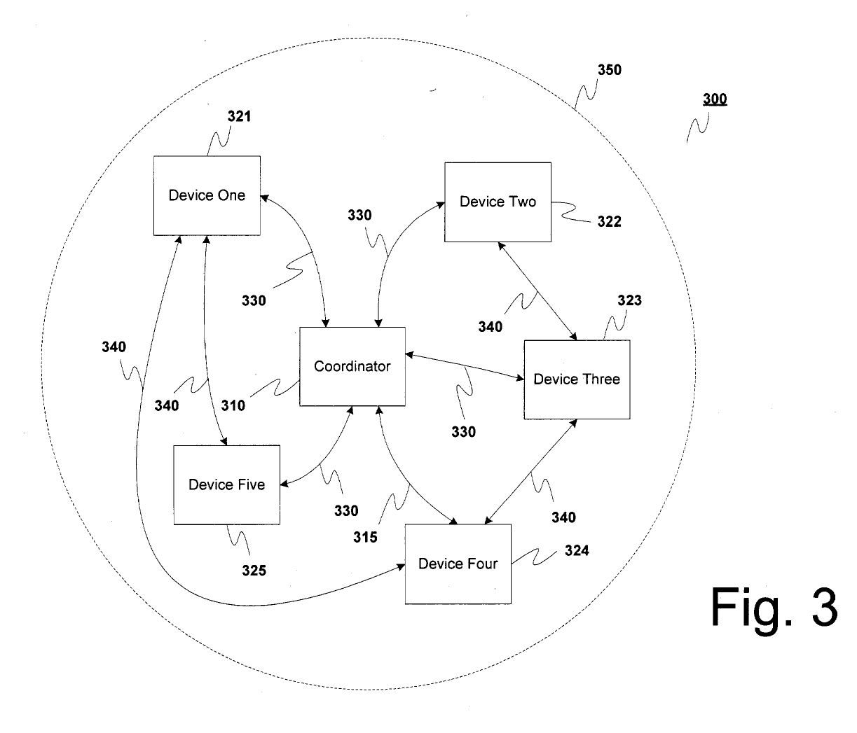

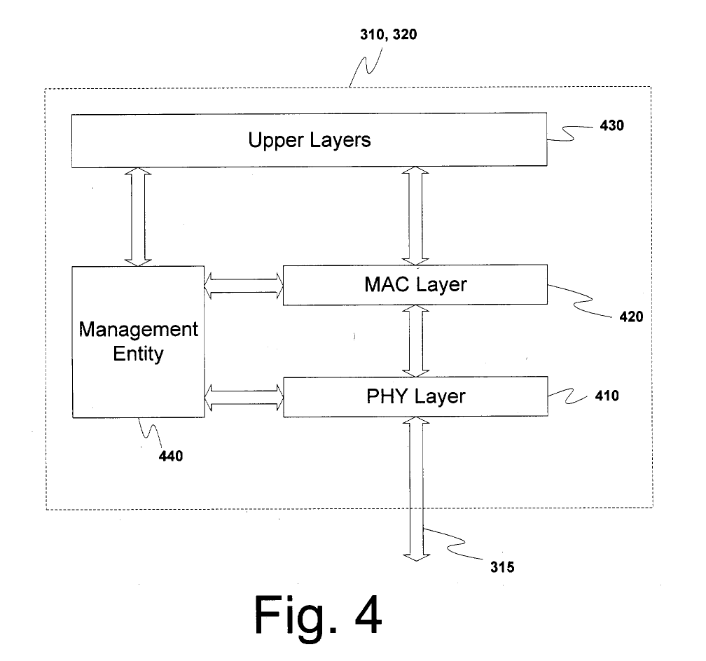

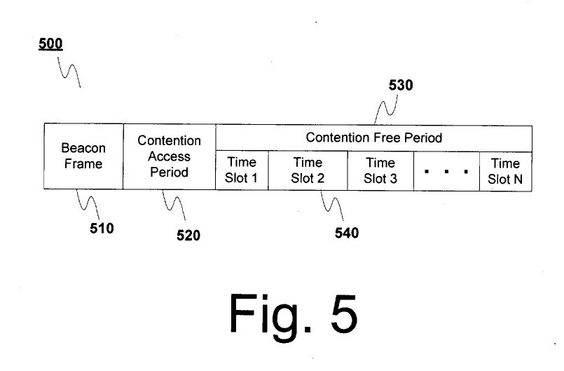

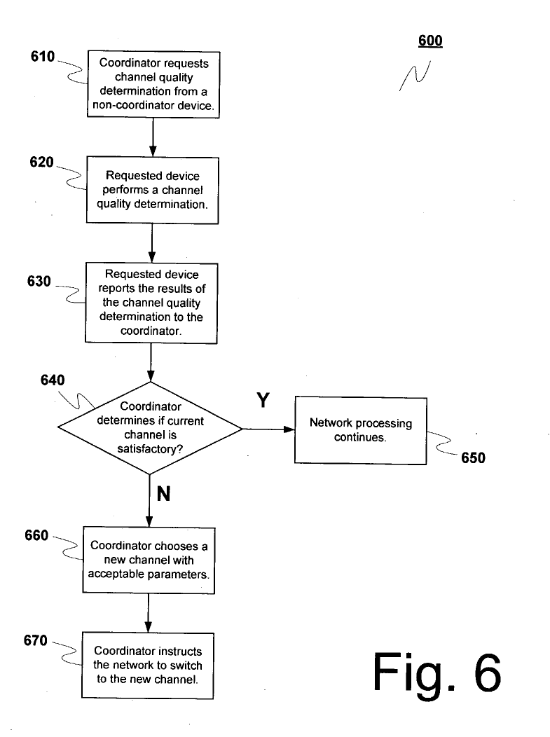

### DETAILED DESCRIPTION OF THE PREFERRED EMBODIMENTS

In a network with multiple channels, the coordinator 310 of a network 300 preferably has a way of determining the quality of each available channel. This channel quality determination method is preferably used when a network is initially formed. In that situation, the coordinator 310 will make an initial channel quality determination, and based on that initial determination, choose a channel to use for operation.

In a preferred embodiment, during a channel quality determination, the coordinator 310 will cycle through all of the available channels, listening and measuring them by set criteria (e.g., amount of noise, magnitude or frequency of interfering signals, the number of other networks in operation, etc.). When it has finished examining all of the channels, the coordinator 310 will determine a desired channel to use and will inform existing devices 321-325 of the chosen channel. Operation of the network 300 will then commence, using the chosen transmission channel.

These channels should not be limited to separate carrier frequency channels. In ultrawide bandwidth (UWB) transmissions, the channels could be defined by different center frequencies. In some embodiments the channels can be virtual channels, e.g., defined by the use of a set of CDMA codes, or any other acceptable means of isolating communications between a set of devices. For example, fixed channel time allocations may be used with networks that are dependent upon other networks to create individual channels for the networks. In other embodiments, a combination of channelization methods could be used. For example, in different channels could be defined by a combination of center frequency and CDMA code. However, regardless of how they are formed, each channel is characterized in that it is a way of transmitting signals over the network 300 that will not interfere with signals sent over the other channels.

As the network continues operation, however, it may be desirable to switch channels. For example, the current channel might begin to experience interference. Or it the network may consider the other channels from time to time to determine if one is of a better quality than the current channel. It may, therefore, be desirable to periodically determine the quality of all of the available channels in the network 300. And to avoid shutting down the operation of the network 300, the job of channel quality determination is performed by one of the non-coordinator devices 321-325 in the network 300, not the network coordinator.

In many networks, multiple devices maintain the ability to determine channel quality. For example, in IEEE 802.15.3 networks, all capable devices are required to be able to scan through a list of channels to either detect a particular network or to create a list of detected networks. In addition, every device in an 802.15.3 network is assumed to have the capability to rate each channel scanned according to whether a channel has detectable RF energy or not.

Thus, if there are non-coordinator devices 321-325 within a network 300 that are capable of performing a channel quality determination, the coordinator 310 may request one of those non-coordinator devices 321-325 to perform such a function and report back to the coordinator 310 with the results. The coordinator 310 can then continue with network processing, allowing the requested non-coordinator device 321-325 to stop only its own operations while it determines the quality of the existing channels. And in some cases, if the requested non-coordinator device 321-325 can perform the channel quality determination quickly enough, it may not have to stop its own operations to any significant degree.

Once the requested non-coordinator device 321-325 provides the channel quality information, the coordinator 310 can determine whether a switch in the current channel is warranted, and if so, what the new channel should be. A more detailed description of this process follows.

FIG. 6 is a flow chart showing a process by which a coordinator 310 can determine the channel quality without stopping network operation, according to a preferred embodiment of the present invention.

As shown in FIG. 6, process 600 begins when the coordinator 310 requests that a particular non-coordinator device 321-325 perform a channel quality determination to determine the status of each available channel. (Step 610)

The requested non-coordinator device 321-325 will then perform a channel quality determination. (Step 620) This channel quality determination preferably comprises listening to each of the available channels, and determining the quality of each channel based on a particular set of criteria. Preferably these criteria include (a) whether there is any radio frequency (RF) energy being transmitted over each band, and (b) whether that RF energy (i.e., RF signal) is decodable or not. These criteria may also include the identity of any other networks 300 that are detected to be transmitting, and whether any detected RF energy is periodic or not.

The channel quality determination may or may not require the requested non-coordinator device 321-325 to break off contact with the network 300. If the requested non-coordinator device 321-325 need not remain in constant contact with the network 300, it may have a set period of time (e.g., an associated timeout period in an 802.15.3 network) during which it can safely be out of contact with the network 300. In such a case, requested non-coordinator device 321-325 may avoid breaking off contact with the network 300 if it finishes the channel quality determination and returns to its network 300 before the set period of time expires.

After it has completed the quality determination, the requested non-coordinator device 321-325 reports the results of the channel quality determination to the coordinator 310. (Step 630) At this point, the requested non-coordinator device 321-325 returns to contact with the network 300 (if it ever left) and carries on with its normal processing.

Based on the results from the remote channel quality determination, the coordinator 310 then determines whether the current channel is satisfactory. (Step 640) This may involve considering the quality of the current channel, and the relative quality of all of the other available channels. Any channel that is currently in use by another network 300, or which is subject to interference from another source, will be more likely to be determined unsatisfactory.

If the current channel is determined to be satisfactory in step 640, then network processing continues without any change in the choice of channel used. (Step 650) In this case, the coordinator 310 determines that either the current channel is either adequate for the current processing or is the best available channel.

If the current channel is determined to be unsatisfactory in step 640, then the coordinator 310 chooses a new channel that has acceptable parameters (Step 660), and then instructs the network to switch to the new channel (Step 670). If all available channels are determined to be unsatisfactory, then the coordinator 310 preferably performs a set of functions designed to avoid the interference.

These interference-avoiding functions may include requesting that the current network 300 become a dependent network of another existing network, changing channel time allocations to avoid a periodic interferer, adjusting maximum transmit power or maximum transmit rate, or shut down the network.

These interference-avoiding functions may also include using a given channel, but avoiding transmission during a periodic interference signal. For example, if an interfering radar periodically provides a high energy pulse

If the coordinator 310 desires that its network 300 join another network as a dependent network (e.g., a child or neighbor network), it returns to the least unsatisfactory channel containing an interfering network, and issues a request to the coordinator of that network to become a dependent network of that incumbent network. If this request is accepted, then the requesting coordinator informs its previous network devices which channel to switch to and for which network ID to listen. If this request is denied by the incumbent coordinator, the requesting coordinator 310 continues operating its current network 300 and performs another interference-avoiding function.

In some embodiments the request in Step 610 will be acknowledged by the requested non-coordinator device 321-325; in others, it will not. Regardless, a timeout period will preferably be established. If the timeout period is passed without the coordinator 310 receiving an acknowledgement or response from the requested non-coordinator device 321-325, then the scan process should be considered a failure, and the coordinator should repeat the request, if necessary. In this case, the coordinator 310 could send the request to the same non-coordinator device 321-325, or to a different non-coordinator device 321-325, depending upon the circumstances.

In addition, although the above description has described a process for performing a channel quality determinations of all of the available channels, a quality determination of all available channels need not be performed. In alternate embodiments a smaller subset of available channels could be scanned. In some embodiments a request can be made to perform an analysis on only the current channel being used. In this case, it is possible that more detailed information can be provided regarding the quality and parameters of the current channel.

In general, a channel quality determination preferably involves looking at some or all of the available channels and determining whether there is decodable or non-decodable RF energy being passed on that channel. If decodable energy is found, the analyzing device 321-325 will determine the identity of the source of those transmissions so that later communications will be possible between the current network and that interfering network, if necessary. In non-decodable energy is found, the analyzing device 321-325 will try and determine the periodicity of the interfering signal so that a later determination can be made as to whether the interfering signal can be avoided in time.

A specific description of the primitives and requests that can be used to implement the above scheme are disclosed in provisional patent application Serial No. 60/380,385, filed May 17, 2002, entitled METHOD OF REMOTE SCANNING, the contents of which have been incorporated by reference into this application.

Obviously, numerous modifications and variations of the present invention are possible in light of the above teachings. For example, although the examples given are all ultrawide bandwidth network examples, the system and methods disclosed above are equally applicable to other wireless networks. It is therefore to be understood that within the scope of the appended claims, the invention may be practiced otherwise than as specifically described herein.

What is claimed is:

1. A method of making a quality determination for a plurality of signal channels in a wireless network, comprising:
sending a channel quality request from a coordinator device in the network to a non-coordinator device in the network;
performing a channel quality determination at the non-coordinator device to determine channel quality information about the plurality of signal channels; and
sending the channel quality information from the non-coordinator device to the coordinator device.

2. A method of making a quality determination for a plurality of signal channels in a wireless network, as recited in claim 1, wherein the step of performing the channel quality determination is accomplished by having the non-coordinator device monitor each of the plurality of signal channels in turn.

3. A method of making a quality determination for a plurality of signal channels in a wireless network, as recited in claim 1, wherein each of the plurality of signal channels has a different carrier frequency.

4. A method of making a quality determination for a plurality of signal channels in a wireless network, as recited in claim 1, wherein each of the plurality of signal channels has a different center frequency.

5. A method of making a quality determination for a plurality of signal channels in a wireless network, as recited in claim 1, wherein each of the plurality of signal channels operates using a unique CDMA code.

6. A method of making a quality determination for a plurality of signal channels in a wireless network, as recited in claim 1, wherein each of the plurality of signal channels has a different combination of center frequency and CDMA code.

7. A method of making a quality determination for a plurality of signal channels in a wireless network, as recited in claim 1, wherein the non-coordinator device suspends normal operation during the step of performing channel quality determination.

8. A method of making a quality determination for a plurality of signal channels in a wireless network, as recited in claim 1, wherein the non-coordinator device does not participate in communication with the network during the step of performing the channel quality determination.

9. A method of making a quality determination for a plurality of signal channels in a wireless network, as recited in claim 1, wherein the channel quality information indicates the presence or absence of radio frequency interference in each signal channel.

10. A method of making a quality determination for a plurality of signal channels in a wireless network, as recited in claim 9, wherein the channel quality information further indicates the periodicity of any radio frequency interference in each signal channel.

11. A method of making a quality determination for a plurality of signal channels in a wireless network, as recited in claim 1, wherein the wireless network is an ultrawide bandwidth network.

12. A method of making a quality determination for a plurality of signal channels in a first wireless network, comprising:
sending a channel quality request from a coordinator device in the local network to a non-coordinator device in the network;
performing a channel quality determination at the non-coordinator device to determine channel quality information about the plurality of signal channels; and
sending the channel quality information from the non-coordinator device to the coordinator device,
wherein the channel quality information indicates the presence or absence of one or more overlapping wireless networks on one or more of the plurality of signal channels.

13. A method of making a quality determination for a plurality of signal channels in a wireless network, as recited in claim 12, wherein the step of performing the channel quality determination is accomplished by having the non-coordinator device monitor each of the plurality of signal channels in turn.

14. A method of making a quality determination for a plurality of signal channels in a first wireless network, as recited in claim 12, wherein the channel quality information further indicates the identities of any overlapping wireless networks.

15. A method of making a quality determination for a plurality of signal channels in a first wireless network, as recited in claim 12, wherein the channel quality information further indicates the presence or absence of radio frequency interference.

16. A method of making a quality determination for a plurality of signal channels in a first wireless network, as recited in claim 15, wherein the channel quality information further indicates the periodicity of any radio frequency interference.

17. A method of making a quality determination for a plurality of signal channels in a first wireless network, as recited in claim 12, wherein each of the plurality of signal channels has a different carrier frequency.

18. A method of making a quality determination for a plurality of signal channels in a first wireless network, as recited in claim 12, wherein each of the plurality of signal channels has a different center frequency.

19. A method of making a quality determination for a plurality of signal channels in a first wireless network, as recited in claim 12, wherein each of the plurality of signal channels operates using a unique CDMA code.

20. A method of making a quality determination for a plurality of signal channels in a first wireless network, as recited in claim 12, wherein each of the plurality of signal channels has a different combination of center frequency and CDMA code.

21. A method of making a quality determination for a plurality of signal channels in a first wireless network, as recited in claim 12, wherein the first wireless network and any overlapping wireless networks are ultrawide bandwidth networks.
